(19) United States
(12) Patent Application Publication
(10) Pub. No.: US 2009/0160208 A1
(43) Pub. Date: Jun. 25, 2009

(54) VEHICLE VISOR ASSEMBLY

(75) Inventors: Alan Sturt, West Bloomfield, MI (US); Joel Carpenter, Richland, MI (US); James J. Hobson, Hanover, MI (US); Derik Reichhart, Coldwater, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 11/962,554

(22) Filed: Dec. 21, 2007

(51) Int. Cl. B60J 3/02

(52) U.S. Cl. 296/97.9

(57) ABSTRACT

A visor support is disclosed with a support arm and a rotation control member. The support arm is adapted to support a visor body and has a first end adapted to be mounted in a vehicle. The support arm has a tapered portion near a second end of the support arm and a ring proximate to the tapered portion. The rotation control member has at least one wall with at least one aperture therein. The rotation control member has a tapered receptacle aligned with the at least one aperture. The rotation control member is rotatable about a linear axis of the support arm such that the tapered portion and the tapered receptacle cooperate to prevent rotation of the support arm absent an external force. The ring cooperates with the rotation control block to at least retain the support arm within the rotation control member.

### BACKGROUND

1. Technical Field

The invention relates to a vehicle visor assembly and a support therefore.

2. Background Art

Vehicles are often provided with a visor assembly to shield an occupant's eyes from light so that the occupant can see out of the vehicle. A support mechanism is typically employed to support the visor in the vehicle. Examples of visor assemblies and/or support assemblies are disclosed in U.S. Pat. No. 6,679,538, which issued on Jan. 20, 2004 to Sturt; and U.S. Pat. No. 6,923,490, which issued on Aug. 2, 2005 to Peterson et al., which are incorporated in their entirety by reference herein.

### SUMMARY

In one embodiment, a visor support assembly having a support arm and a rotation control member is disclosed. The support arm is adapted to support a visor body and has a first end adapted to be mounted in a vehicle. The support arm has a tapered portion near a second end of the support arm and a ring proximate to the tapered portion. The rotation control member has at least one wall with at least one aperture therein sized to receive a portion of the second end of the support arm therethrough. The rotation control member has a tapered receptacle aligned with the at least one aperture and provided on the at least one wall. The rotation control member is rotatable about a linear axis of the support arm such that the tapered portion of the support arm and the tapered receptacle of the rotation control member cooperate to prevent rotation of the support arm absent an external force. The ring cooperates with the rotation control block to at least retain the support arm within the rotation control member.

In another embodiment, a visor assembly for a vehicle is disclosed. The visor assembly has a support arm and a rotation control member. The support arm has a first end and a second end with an included angle therebetween. The first end is adapted to be mounted in a vehicle. The support arm has a tapered portion near the second end of the support arm. The rotation control member has a first wall with a first aperture therein, a second wall with a second aperture therein and a third wall with a third aperture therein. Each of the first, second and third apertures is sized to receive a portion of the second end of the support arm therethrough to align the support arm. The rotation control member with a tapered receptacle aligned with one of the first, second and third apertures, is provided on one of the first, second and third walls. The rotation control member is rotatable about a linear axis of the support arm such that the tapered portion of the support arm and the tapered receptacle of the rotation control member cooperate to prevent rotation of the support arm absent an external force.

### BRIEF DESCRIPTION OF THE DRAWINGS

FIG. 1 is a perspective view of an embodiment of a visor assembly in an extended position;

FIG. 2 is a perspective view of the visor assembly of FIG. 1 in a stored position;

FIG. 3 is an exploded front elevation view of an embodiment of a visor support mechanism of FIG. 1;

FIG. 4 is a front elevation view of the visor support mechanism of FIG. 3 illustrated in an extended position;

FIG. 5 is a top plan view of the visor support mechanism of FIG. 3 illustrated in a stored position;

FIG. 6 is a perspective view of the visor support mechanism of FIG. 3; and

FIG. 7 is a cross-sectional view of an embodiment of the visor support mechanism of FIG. 3.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

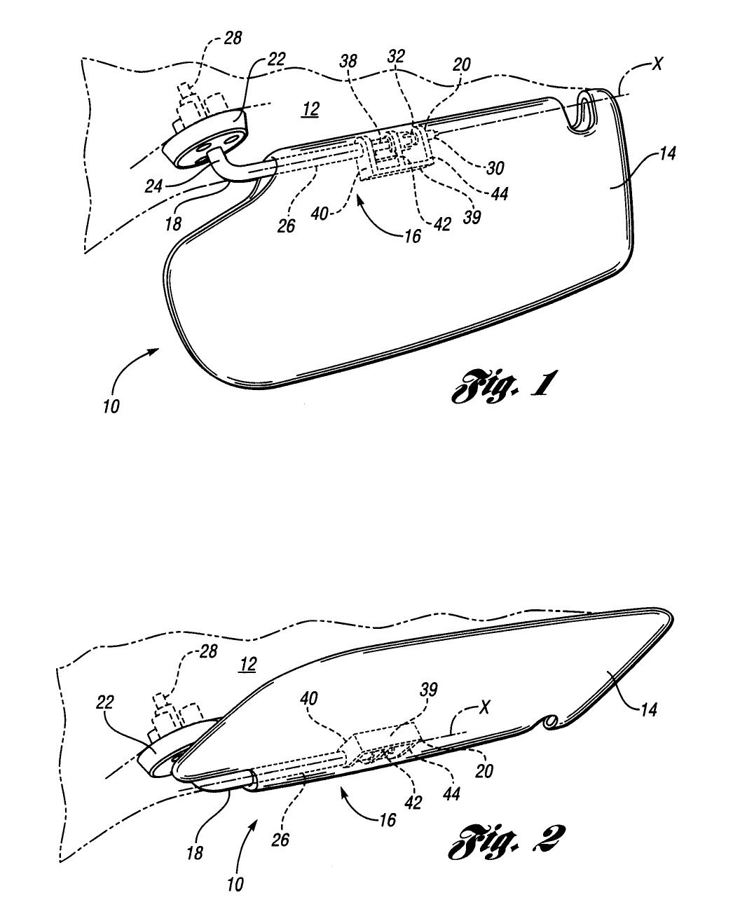

Referring to FIG. 1, a visor assembly is illustrated and generally referenced by the numeral 10. As depicted, the visor assembly 10 is mounted to a vehicle at a vehicle roof 12. The visor assembly 10 may be mounted to a vehicle in any suitable location, for example on any upright structural member such as a pillar or on any cross structural member. When in an extended position as illustrated, the visor assembly 10 is generally used to shield an occupant's eyes from sunlight or other light, which may enter an interior of the vehicle through a windshield or a side window. The visor assembly 10 may have a mirror or other ancillary component provided thereon.

The visor assembly 10 has a visor body 14, which shields the occupant's eyes from sunlight or other light by providing shade on the occupant's eyes. In one embodiment, the visor body 14 is formed as a single piece from a plastic material, such as polypropylene. The visor body 14 may be molded. Of course, the visor body 14 may be made out of any suitable material and may be formed out of any suitable number of components. In one embodiment, the visor body 14 is covered with upholstery to enhance a trim appearance within the vehicle. Any suitable visor body 14 is contemplated within the scope of the present invention.

The visor body 14 is mounted to the roof 12 and supported by a visor support mechanism 16. The visor support mechanism 16 has a support arm 18 and a rotation control block 20. The support arm 18 is pivotally mounted to the roof 12 and is supported by a bracket 22 so that the visor assembly 10 can pivot between the windshield or the side window of the vehicle. The support arm 18 may be mounted to the roof 12 in any suitable manner. In one embodiment, the support arm 18 is integrally formed out of one material. In another embodiment, the support arm is formed out of two or more materials.

The rotation control block 20 is mounted within the visor body 14. The rotation control block 20 controls rotation of the visor body 14 about an axis X, which generally extends along a portion of the support arm 18. The rotation control block 20 is utilized to control torque of the visor body 14. Together the support arm 18 and the rotation control block 20 can control the torque of the visor body 14 to hold the visor body 14 in an extended position, as illustrated in FIG. 1, in a stored position, as illustrated in FIG. 2, or in a desired position between the extended position and the stored position.

Torque control for the visor assembly 10 is necessary because weight of the visor body 14 is distributed away from the support arm 18 since the visor body 14 extends away from the support arm 18. Thus, the rotation control block 20 is utilized for torque control to stop undesired rotation of the visor body 14 about the axis X. The visor body 14 can be rotated about the axis X when an occupant exerts a force on the visor body 14 that overcomes the torque control on the visor assembly 10 provided by friction between the support arm 18 and the rotation control member 20.

The prior art provides torque control for a visor assembly by providing a controller that employs a separate biasing member, which is typically a spring made out of a metal alloy. The metal alloy spring has high manufacturing costs because of material costs for the metal and assembly costs to assemble the additional component. The metal alloy spring has a large weight when compared to a plastic material. Additionally, the metal alloy spring typically requires a lubricant when utilized with a support arm within a vehicle visor assembly because of the high friction caused by the metal alloy of the spring on the support arm. The addition of lubricant also increases manufacturing costs of the visor assembly. Utilization of the support arm 18 and the rotation control member 20 as described in the multiple embodiments of the present invention reduces these manufacturing costs for the visor assembly 10 by providing a lightweight assembly that is inexpensive to manufacture.

As illustrated in FIGS. 1-2, the visor assembly 10 is mounted on a left side of the vehicle, which is typically the driver side of the vehicle in a U.S. motor vehicle. Of course, the visor assembly 10 can be modified in any suitable manner to be installed on the left side of a vehicle, which is typically a passenger side of the vehicle in a U.S. motor vehicle. The visor assembly 10 can be modified to be installed in any other desired location within the vehicle.

A portion of the support arm 18 is received through the rotation control block 20, which is mounted within the visor body 14. When an occupant rotates the visor body 14, the rotation control block 20 and the visor body 14 collectively rotate about the support arm 18. The rotation control block 20 allows the visor body 14 to pivot about the axis X, between an extended position, illustrated in FIG. 1, and a stored position, illustrated in FIG. 2. The rotation control block 20 can selectively hold the visor body 14 in any desired position between the extended position and the stored position by applying sufficient torque to hold the visor body 14 without utilization of an additional biasing member such as a spring formed from a metal alloy.

In FIG. 1, the visor assembly 10 is in an extended position so that the visor body 14 blocks light from entering the eyes of the occupant. The extended position illustrated is generally near and/or parallel with a windshield or side window of the vehicle. In FIG. 2, the visor assembly 10 is in a stored position so that the visor body 14 is generally near and/or parallel with the roof 12 of the vehicle so that the visor body 14 is generally out of a line of vision of the occupant.

In at least one embodiment, the rotation control block 20 is made out of a plastic material, such as polypropylene, which is an inexpensive material. Additionally, the rotation control block 20 can be made out of any polymeric material including, but not limited to: nylon, acrylonitrile butadiene styrene (ABS), polycarbonate acrylonitrile butadine styrene (PCABS) and acetal. Utilization of a plastic material for the entire rotation control block 20 allows the visor assembly 10 to have a lighter weight than in the prior art because plastic materials have a lighter weight than metal alloys. In another embodiment, the rotation control block 20 is formed through injection molding such that all components of the rotation control block 20 are collectively formed in one step. Manufacturing the rotation control block 20 in one step allows for a reduction in manufacturing time to decrease manufacturing costs and also decreases material costs by reducing the number of components required for the visor support mechanism 16 and the visor assembly 10.

Referring now to FIGS. 1-4, the support arm 18 has a generally L-shape formed with an upright member 24 connected to an elongate member 26. The upright member 24 has a first end 28, which is mounted to the roof 12 and is supported by a bracket 22. A portion of the upright member 24 extends out of the roof 12 toward the visor body 14. The elongate member 26 is connected to the upright member 24 and has a second end 30. The elongate member 26 is received within the visor body 14.

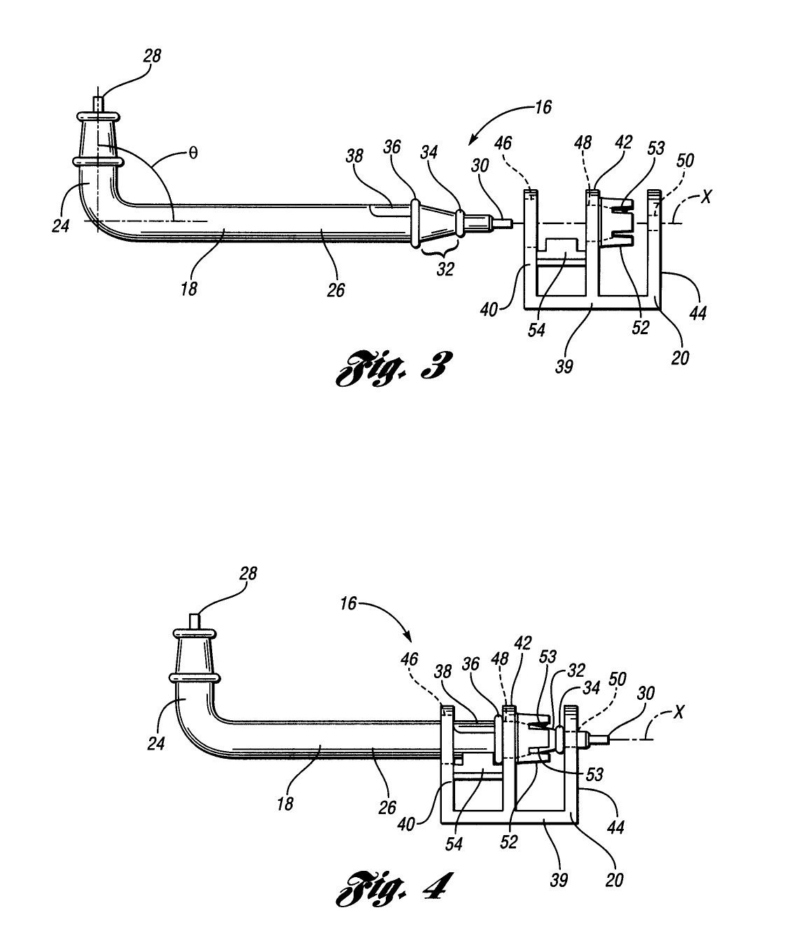

As illustrated in FIG. 3, the upright member 24 and the elongate member 26 of the support arm 18 have an angle Θ therebetween. The angle Θ can be approximately ninety degrees to allow for accurate control of pivotal movement for the support arm 18. Of course, any suitable shape for the support arm 18 and any suitable angle Θ are each contemplated within the scope of the present invention.

The support arm 18 has a tapered portion 32 proximate the second end 30 of the support arm 18. The tapered portion 32 fits within the rotation control block 20, which provides torque to the rotation control member 20 to keep the rotation control block 20 in an extended position, as illustrated in FIG. 4. When the rotation control block 20 is in the extended position, the visor assembly 10 is in the extended position illustrated in FIG. 1 as desired by the occupant.

The support arm 18 has a first ring 34 and a second ring 36 provided on opposite ends of the tapered portion 32. The first ring 34 is provided on the smaller end of the tapered portion 32 while the second ring 36 is provided on the larger end of the tapered portion 32. The first ring 34 is provided on the support arm 18, abutting the rotation control block 20, to provide friction therebetween to hold the support arm 18 and rotation control block 20 in a desired position. The second ring 36 is provided on the support arm 18, abutting another portion of the rotation control block 20, to further provide friction therebetween. The first ring 34 may provide an axial force along the axis X on the support arm 18 in a first direction while the second ring 36 produces an equal axial force in a second direction opposite the first direction to retain the support arm 18 from movement by the axial force.

In one embodiment, the first ring 34 is engaged with the rotation control block 20 to hold the visor 10 in a desired position by the friction between the first ring 34 and the rotation control block 20. The desired position can be between the extended position, illustrated in FIG. 1, and the stored position, illustrated in FIG. 2. In another embodiment, the second ring 36 is provided on the larger end of the tapered portion 32 to produce increased friction between the support arm 18 and the rotation control block 20. In yet another embodiment, the occupant moves the visor body 14 so that the first ring 34 and the second ring 36 snap to a desired position between the extended position and the stored position. In still another embodiment, the first ring 34 and the second ring 36 facilitate alignment between the support arm 18 and the rotation control block 20.

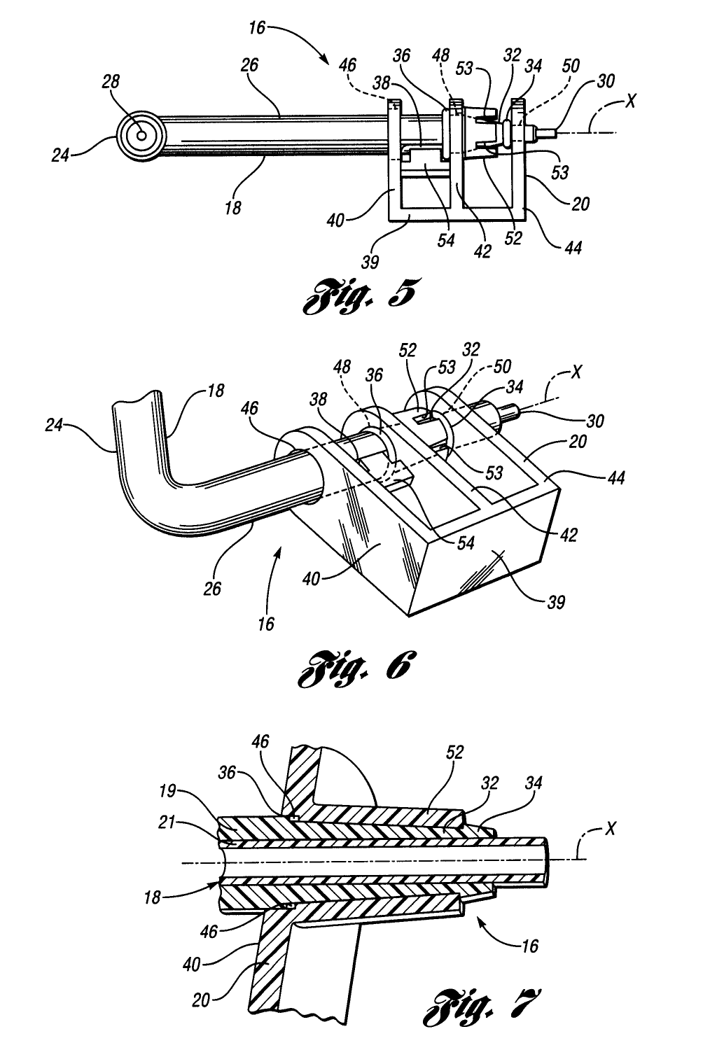

As illustrated, the support arm 18 has a recess 38 formed therein along an axial direction along the axis X. The recess 38 is located generally adjacent to the second ring 36 and proximate to the tapered portion 32. The occupant can engage the rotation control block 20 with the recess 38, which is illustrated in FIGS. 5 and 6, so that the visor body 14 is held in the stored position as illustrated in FIG. 2. When the occupant overcomes the force applied on the recess 38 by the rotation control block 20, as illustrated in FIG. 4, the visor body 14 can be moved to the extended position by rotating the support arm 18 and visor body 14 about the axis X. The occupant may overcome the force provided on the recess 38 by pulling the visor body 14 downward, which allows rotation of the visor body 14.

In at least one embodiment, the rotation control block 20 has a base wall 39, a first wall 40, a second wall 42, and a third wall 44, that collectively provide structure for the rotation control block. In the depicted embodiment, the first wall 40, the second wall 42 and the third wall 44 are generally parallel and are each generally perpendicular to the base wall 39. The first wall 40 has a first aperture 46, which is sized to receive the support arm 18. The second wall 42 has a second aperture 48 that is sized to receive the support arm 18 therethrough. The third wall 44 has a third aperture 50 that is sized to receive the support arm 18. The first aperture 46, the second aperture 48 and the third aperture 50 are generally in alignment, which allows the support arm 18 to pass through the rotation control block 20. In at least one embodiment, the rotation control block 20 has a first wall 40 and a second wall 42. In yet another embodiment, the rotation control block 20 has a first wall 40.

As shown in FIGS. 3-7, the rotation control block 20 has a tapered receptacle 52. The tapered receptacle 52 of the rotation control block 20 abuts the tapered portion 32 to be in frictional contact. The frictional contact between the tapered portion 32 and the tapered receptacle keeps the support arm 18 and the rotation control block 20 in the position illustrated in FIG. 4 that corresponds with the visor assembly 10 being in the extended position illustrated in FIG. 1. In at least one embodiment, the tapered receptacle 52 has slots 53 provided therein so that the tapered receptacle 52 can expand to receive a tapered portion 32 of the support arm 18 with a larger sized diameter than that of the tapered receptacle 52.

Lubricant, such as grease, is not required between the tapered portion 32 and the tapered receptacle 52 because the tapered portion 32 and the tapered receptacle 52 easily rotate against each other without squeaking or other noise since a metal alloy is not employed. The visor support mechanism 16 is reduced in manufacturing costs in comparison to the prior art, which utilizes lubricant on metal alloys.

In one embodiment, the tapered receptacle 52 of the rotation control block 20 has a smaller diameter relative to the tapered portion 32 of the support arm 18. The tapered receptacle 52 is slightly undersized relative to the tapered portion 32 so that an interference fit or friction fit exists between the tapered receptacle 52 and the tapered portion 32. The interference fit allows rotation of the control block 20 about the axis X.

As depicted in FIGS. 3-6, the rotation control block 20 has a detent protrusion 54 provided between the first wall 40 and the second wall 42. Of course, the detent protrusion 54 may be provided in any suitable location on the rotation control block 20. The detent protrusion 54 can be engaged with the recess 38 of the arm assembly 18 to hold the visor 10 in the stored position as illustrated in FIG. 2. To disengage the detent protrusion 54 from the recess 38, the occupant pulls the visor body 14 downward, which allows the rotation control block 20 and the visor body 14 pivot away from the roof 12 about the axis X.

As seen in FIG. 4-5, the first ring 34 abuts the third wall 44 to provide friction therebetween, which facilitates holding the rotation control block 20 in a desired position relative to the support arm 18. In another embodiment, the first ring 34 abuts the tapered portion 52. As illustrated, the second ring 36 abuts the second wall 42 to provide further friction between the support arm 18 and the rotation control block 20. In yet another embodiment, the first ring 34 provides an axial load on the support arm 18 in a first direction along the axis X and the second ring 36 retains the support arm 18 from movement by the axial load by providing an equal and opposite axial load in a second direction along the axis X.

With reference to FIG. 7, an enlarged view of another embodiment of the visor support mechanism 16 having support arm 18 and rotation control block 20 is illustrated. The rotation control block 20 has a wall 40 with an aperture 46 formed therethrough. The aperture 46 is sized to receive a portion of the support arm 18. A tapered receptacle 52 is mounted on the wall 40 of the rotation control block 20. The tapered receptacle 52 is sized to receive a tapered portion 32 of the support arm 18 and are in frictional contact to control rotation between the support arm 18 and the rotation control block 20 about the axis X.

In the depicted embodiment, the support arm 18 has a ring 34 that abuts the tapered receptacle 52 of the rotation control block 20 to align the support arm 18 within the rotation control block 20 and to prevent removal of the support arm 18 from the rotation control block 20. Of course, the ring 34 may further facilitate restriction of rotation between the support arm 18 and the rotation control block 20 about the axis X through frictional contact between the ring 34 and the tapered receptacle 52.

In at least one embodiment, the support arm 18 has a coating 19 surrounding a rod 21. The coating 19 forms the tapered portion 32 and the ring 34. The coating 19 and rod 21 are made out of different materials, which can be different thermoplastic polymer materials. In another embodiment, the coating 19 is made out of a thermoplastic polymer material and the rod 21 is made out of a metal. In yet another embodiment, the coating 19 and rod 21 are made out of the same material and are integrally formed.

The support arm 18 has a section 36, abutting the larger end of the tapered portion 32, that has a diameter that can be received within the aperture 46. The diameter of the section 36 allows for easy installation of the support arm 18 into the rotation control block 20. Of course the section 36 can have an increased diameter to abut the wall 40, as depicted in FIGS. 3-6.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A visor support assembly comprising:
a support arm adapted to support a visor body and having a first end adapted to be mounted in a vehicle, the support arm having a tapered portion near a second end of the support arm and a ring proximate to the tapered portion; and
a rotation control member having at least one wall with at least one aperture therein sized to receive a portion of the second end of the support arm therethrough, the rotation control member having a tapered receptacle aligned with the at least one aperture and provided on the at least one wall;
wherein the rotation control member is rotatable about a linear axis of the support arm such that the tapered portion of the support arm and the tapered receptacle of the rotation control member cooperate to prevent rotation of the support arm absent an external force and the ring cooperates with the rotation control block to at least retain the support arm within the rotation control member.

2. The visor support assembly of claim 1 wherein the support arm further comprises a recess proximate the tapered portion;
wherein the rotation control member further comprises a detent protrusion such that when the rotation control member is in an extended or stored position, the recess of the support arm engages the detent protrusion to hold the rotation control member in the extended or stored position.

3. The visor support assembly of claim 1 wherein the first ring abuts the tapered receptacle to prevent axial movement of the support arm.

4. The visor support assembly of claim 1 wherein the tapered receptacle of the rotation control member is slightly undersized relative to the tapered portion of the support arm such that a rotatable interference fit exists therebetween.

5. The visor support assembly of claim 1 wherein the tapered portion of the support arm and the tapered receptacle of the rotation control member have a friction engagement therebetween.

6. The visor support assembly of claim 1 wherein the rotation control member is further defined as a thermoplastic polymer material.

7. The visor support assembly of claim 1 further comprising a bracket mounted on the support arm and adapted to rotatably mount the support arm to a roof of a vehicle.

8. The visor support assembly of claim 1 wherein the support arm further comprises a second ring such that the ring and the second ring are provided at opposing ends of the tapered receptacle to further prevent rotation of the support arm absent an external force.

9. The visor support assembly of claim 8 wherein one of the ring and the second ring provide an axial force on the support arm in a first direction and the other of the first ring and the second ring retain the support arm from movement by the axial force.

10. The visor support assembly of claim 1 wherein the at least one wall having at least one aperture further comprises:
a first wall having a first aperture provided therethrough; and
a second wall having a second aperture provided therethrough generally aligned with the first aperture.

11. The visor support assembly of claim 10 wherein the first wall, the second wall and the tapered receptacle of the rotation control member are collectively injected molded.

12. The visor support assembly of claim 11 wherein the tapered receptacle is provided on the second wall.

13. The visor support assembly of claim 12 wherein the tapered receptacle extends away from the first wall.

14. The visor support assembly of claim 10 wherein the rotation control member further comprises a third wall having a third aperture provided therein to align the support arm within the rotation control member.

15. The visor support assembly of claim 14 wherein the support arm further comprises a recess proximate the tapered portion;
wherein the rotation control member further comprises a detent protrusion mounted between the first and second walls of the rotation control member such that when the rotation control member is in an extended or stored position, the recess of the support arm engages the detent protrusion to hold the rotation control member in the extended or stored position.

16. The visor support assembly of claim 14 wherein the first end and the second end of the support arm have an included angle of approximately ninety degrees therebetween.

17. The visor support assembly of claim 14 wherein the rotation control member further comprises a base wall and each of the first, second and third walls extend from the base wall.

18. A visor assembly for a vehicle, the visor assembly comprising:
a support arm having a first end and a second end with an included angle therebetween, the first end adapted to be mounted in a vehicle, the support arm having a tapered portion near the second end of the support arm; and
a rotation control member and having a first wall with a first aperture therein, a second wall with a second aperture therein and a third wall with a third aperture therein, each of the first, second and third apertures sized to receive a portion of the second end of the support arm therethrough to generally align the support arm, the rotation control member having a tapered receptacle aligned with one of the first, second and third apertures, provided on one of the first, second and third walls;
wherein the rotation control member is rotatable about a linear axis of the support arm such that the tapered portion of the support arm and the tapered receptacle of the rotation control member cooperate to prevent rotation of the support arm absent an external force.

19. The visor assembly of claim 18 wherein the support arm further comprises a ring proximate the tapered portion to cooperate with the third wall to prevent rotation of the support arm absent an external force.

20. A visor assembly for a vehicle, the visor assembly comprising:
a visor body;
a support member having a first end and a second end with an included angle of approximately ninety degrees therebetween, the first end adapted to be mounted in a vehicle, the support member having a tapered portion near the second end of the support member, a pair of rings at opposing ends of the tapered portion, and a recess proximate one of the pair of rings; and
a thermoplastic polymer rotation control member mounted within the visor and having a first wall with a first aperture therein, a second wall with a second aperture therein and a third wall with a third aperture therein, each of the first, second and third apertures sized to receive a portion of the second end of the support member to generally align the support member, the thermoplastic polymer rotation control member having a tapered receptacle aligned with one of the first, second and third apertures provided between the second and third walls and extending toward the third wall, and having a detent protrusion mounted between the first and second walls;
wherein the visor is rotatable about a linear axis of the support member between a stored position and an extended position such that the tapered portion of the support member and the tapered receptacle of the thermoplastic polymer rotation control member cooperate to control rotation of the visor and the pair of rings cooperate with the tapered portion and the second wall to hold the visor to prevent rotation of the support arm absent an external force and the recess of the support member engages the detent protrusion of the thermoplastic polymer rotation control member to selectively secure the visor in the stored position.
